(19) United States
(12) Patent Application Publication
(10) Pub. No.: US 2015/0227540 A1
(43) Pub. Date: Aug. 13, 2015

(54) SYSTEM AND METHOD FOR CONTENT-AWARE DATA COMPRESSION

(71) Applicant: HITACHI, LTD., TOKYO (JP)

(72) Inventors: Wujuan LIN, SINGAPORE (SG); Hirokazu IKEDA, SINGAPORE (SG); Hitoshi KAMEI, Sagamihara-shi (JP); Takayuki FUKATANI, Wokingham (GB)

(73) Assignee: HITACHI, LTD., TOKYO (JP)

(21) Appl. No.: 14/178,924

(22) Filed: Feb. 12, 2014

(51) Int. Cl. G06F 17/30

(52) U.S. Cl. CPC G06F 17/30153

(57) ABSTRACT

Exemplary embodiments provide a data compression technique which chooses a compression method without compressing data. A storage system comprises a storage media and a controller. The controller is operable to: determine a compression method to be used to compress a data block of uncompressed data based on one or more characteristics of data content of the uncompressed data prior to compressing the data block; and compress the data block of the uncompressed data using the determined compression method. In some embodiments, the controller is operable to determine the compression method based on a compression rule which relates one or more characteristics of data content and compression methods. In specific embodiments, the storage system further comprises a flash memory device which includes the controller to determine the compression method and to compress the data block.

### BACKGROUND OF THE INVENTION

The present invention relates generally to data storage and, more particularly, to a method for content-aware data compression.

Big Data Analytics systems store and analyze large and rapidly growing amounts of data, such as transaction logs, sensor data, and so on. Storage cost, while decreasing over time, still consumes a large portion of the system cost. Enterprises are continually looking for advanced Data Compression techniques to save storage cost. Although compressing data in column-oriented format typically obtains better compression ratio than row-oriented format, the challenge lies in how to choose the best compression method automatically to compress different data. In addition, even within the same column, data pattern may change, and various data compression methods should be used for the best compression result. Such fine-grain data compression poses another challenge.

Existing technologies of transparent data compression can be found in file systems and databases. For file systems, such as BtrFS and FuseCompress, the data compression method is fixed once the file system is mounted, and all the files in the file system are compressed using the same compression method. It is not content-aware. For databases, US20110320418 uses multiple compression methods to compress sample data of a column, and selects the compression method with the best result to compress the whole column. It does not change the compression method even if data pattern in the column changes, which may result in a lower compression result. On the other hand, U.S. Pat. No. 8,489,555 uses multiple methods to compress each data chunk of a column, and chooses the compressed data with the best result. Different compression methods may be used to compress different data chunks of the same column. However, it is inefficient in selecting the compression method.

### BRIEF SUMMARY OF THE INVENTION

Exemplary embodiments of the invention provide a new data compression technique which chooses a compression method without compressing data, based on characteristics of data content and a compression rule, and then compresses data using the chosen compression method. The compression method can be changed, if the characteristics of data content change.

In accordance with an aspect of the present invention, a storage system comprises a storage media and a controller. The controller is operable to: determine a compression method to be used to compress a data block of uncompressed data based on one or more characteristics of data content of the uncompressed data prior to compressing the data block; and compress the data block of the uncompressed data using the determined compression method.

In some embodiments, the controller is operable to determine the compression method based on a compression rule which relates one or more characteristics of data content and compression methods. The one or more characteristics of data content comprise one or more of: whether the data is string data or numeric data; if the data is string data, whether the data has an average run length larger than a run length threshold; if the data is numeric data, whether the data is sorted or not; whether the data has an average value repeated time larger than a repeated time threshold; or whether the data is float or integer.

In specific embodiments, the controller is operable to: determine a compression result of the compressed data block; compare the compression result with a compression result threshold; if the compression result is below the compression result threshold, decide that the compression method can be changed for a next data block of uncompressed data to be compressed; and if the compression result is not below the compression result threshold, decide that the compression method cannot be changed for the next data block of uncompressed data to be compressed.

In some embodiments, information on whether the compression method can be changed or not and the compression method are stored in the storage media. The controller is operable to: prior to determining a compression method to be used to compress the next data block of uncompressed data, check the stored information on whether the compression method can be changed or not; if the stored information indicates that the compression method can be changed, then determine a next compression method to be used to compress the next data block of uncompressed data based on one or more characteristics of data content of the uncompressed data prior to compressing the next data block, and compress the next data block of the uncompressed data using the determined next compression method; and if the stored information indicates that the compression method cannot be changed, then compress the next data block of the uncompressed data using the stored compression method.

In specific embodiments, the controller is operable to: detect data content of sample data of the data block of the uncompressed data; and use the data content of the sample data to determine the compression method to be used to compress the data block.

In some embodiments, the storage system further comprises a flash memory device which includes the controller to determine the compression method and to compress the data block. The controller in the flash memory device is operable to: determine a compression result of the compressed data block; compare the compression result with a compression result threshold; if the compression result is below the compression result threshold, decide that the compression method can be changed for a next data block of uncompressed data to be compressed; and if the compression result is not below the compression result threshold, decide that the compression method cannot be changed for the next data block of uncompressed data to be compressed.

In specific embodiments, information on whether the compression method can be changed or not and the compression method are stored in the storage media; and further comprising a system controller which is operable to: prior to determining a compression method to be used to compress the next data block of uncompressed data, check the stored information on whether the compression method can be changed or not; if the stored information indicates that the compression method can be changed, then request the flash memory device to determine a next compression method to be used to compress the next data block of uncompressed data based on one or more characteristics of data content of the uncompressed data prior to compressing the next data block, and to compress the next data block of the uncompressed data using the determined next compression method; and if the stored information indicates that the compression method cannot be changed, then request the flash memory device to compress the next data block of the uncompressed data using the stored compression method.

Another aspect of the invention is directed to a method of compressing data in a storage system which includes a storage media. The method comprises: determining a compression method to be used to compress a data block of uncompressed data based on one or more characteristics of data content of the uncompressed data prior to compressing the data block; and compressing the data block of the uncompressed data using the determined compression method.

These and other features and advantages of the present invention will become apparent to those of ordinary skill in the art in view of the following detailed description of the specific embodiments.

### BRIEF DESCRIPTION OF THE DRAWINGS

FIG. 1 is an exemplary diagram of an overall system according to the present invention.

FIG. 2 is a block diagram illustrating an example of the components within a storage system according to the first embodiment.

FIG. 3 illustrates an example where data used by a Big Data Analysis are stored in a column-oriented format.

FIG. 4 is a flow diagram illustrating the exemplary steps, executed by a file system program in a storage system, to serve a write request from a client, according to the first embodiment.

FIG. 5 shows an example of the structure of an inode according to the first embodiment.

FIG. 6 is a flow diagram illustrating the exemplary steps of a data block compression program, upon receiving a compression request, according to the first embodiment.

FIG. 7 is a flow diagram illustrating the exemplary steps of a property detection program.

FIG. 8 shows an example of a compression rule.

FIG. 9 shows an example of the structure of a compression goal.

FIG. 10 shows an example of the structure of a compression method lookup table.

FIG. 11 shows an example illustrating that the data blocks of different columns may be compressed with different compression methods, and data blocks belonging to the same column may also be compressed with different compression methods.

FIG. 12 is a flow diagram illustrating the exemplary steps, executed by a file system program in a storage system, to serve a read request from a client, according to the first embodiment.

FIG. 13 is a block diagram illustrating an example of the components within a storage system according to the second embodiment.

FIG. 14 is a flow diagram illustrating the exemplary steps, executed by a file system program in a storage system, to serve a write request from a client, according to the second embodiment.

FIG. 15 is a flow diagram illustrating the exemplary steps of a compression initiator program upon receiving a compression request.

FIG. 16 is a flow diagram illustrating the exemplary steps of a data block compression program, executed by a flash device in a storage system, upon receiving a compression request, according to the second embodiment.

FIG. 17 is a flow diagram illustrating the exemplary steps, executed by a file system program in a storage system, to serve a read request from a client, according to the second embodiment.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium including non-transitory medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for content-aware data compression.

### Embodiment 1

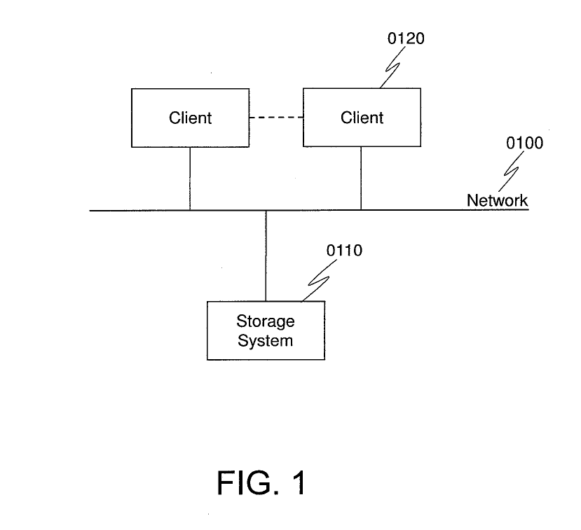

FIG. 1 is an exemplary diagram of an overall system according to the present invention. The system includes a storage system 0110 and a plurality of clients 0120 connected to a network 0100 (such as local area network). Storage system 0110 is the device (such as network attached storage) where data are compressed and stored. Clients 0120 are the devices (such as PCs) that access the data from storage system 0110.

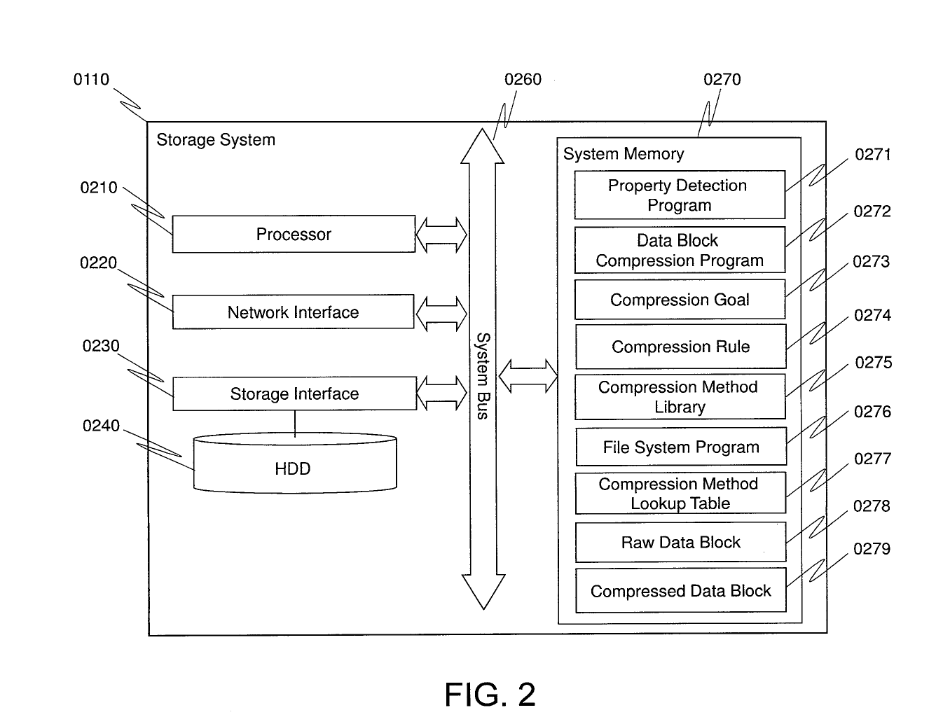

FIG. 2 is a block diagram illustrating an example of the components within a storage system 0110 according to the first embodiment. The storage system may include, but is not limited to, a processor 0210, a network interface 0220, a storage interface 0230, a storage media such as HDD (Hard Disk Drives) 0240, a system bus 0260, and a system memory 0270. The system memory 0270 includes, but is not limited to, a property detection program 0271, a data block compression program 0272, and a file system program 0276, which are computer programs executed by the processor 0210. The processor 0210 may also be referred to as a controller or a system controller. The system memory 0270 further includes a compression goal 0273, a compression rule 0274, a compression method library 0275, and a compression method lookup table 0277, which are read and/or written by the programs. The system memory 0270 further includes a raw data block 0278 where an uncompressed user data block is stored, and a compressed data block 0279 where the compressed user data block is stored. The storage interface 0230 manages a plurality of HDDs and provides raw data storage to store the compressed data blocks. Data communicated among the processor and other components are transferred via the system bus 0260. The network interface 0220 connects the storage system 0110 to the network 0100 and is used to serve data access requests from clients 0120, using a protocol such as the NFS (Network File System) protocol.

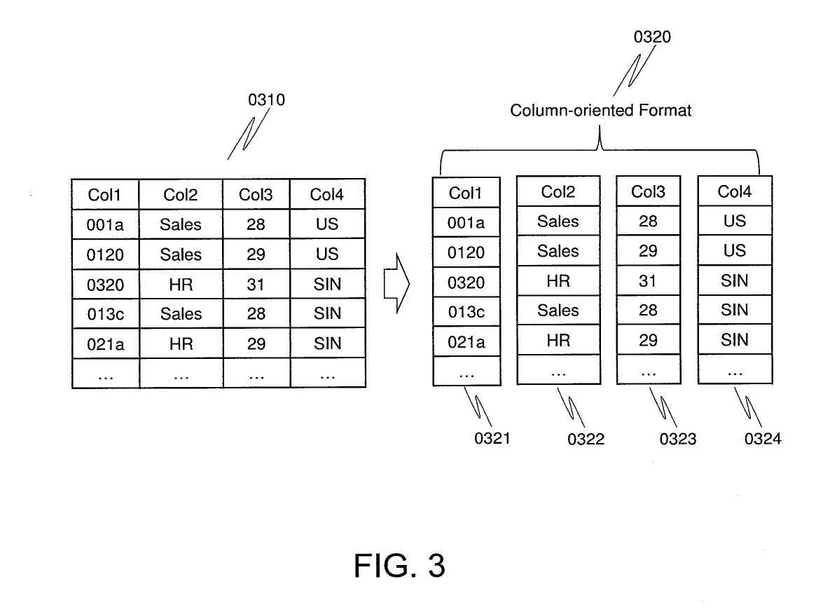

FIG. 3 illustrates an example in which data (e.g., a transaction log) 0310 has multiple attributes or columns (Col1 to Col4). A data analysis application usually analyzes only a portion of the attributes, instead of all the attributes. Therefore, data is typically stored in a column-oriented format 0320 (in which data contents that belong to the same column are stored contiguously), so that only required columns are accessed by the application to reduce the I/O requirement on a storage system 0110. In addition, data in a column may be compressed to minimize storage capacity so as to reduce storage cost. This invention discloses a new data compression technique which is able to choose the best compression method automatically to compress a column data, based on the characteristics of the data content. Typically, a data analysis application analyzes data through a middleware, such as Hadoop or column-oriented database, where each column (0321˜0324) may be stored as a file which has multiple data blocks. A client 0120 accesses the content of a column via a network file access protocol, such as NFS (Network File System), by sending a write or read request to the storage system 0110. In turn, a file system program 0276 in the storage system 0110 will then serve the request.

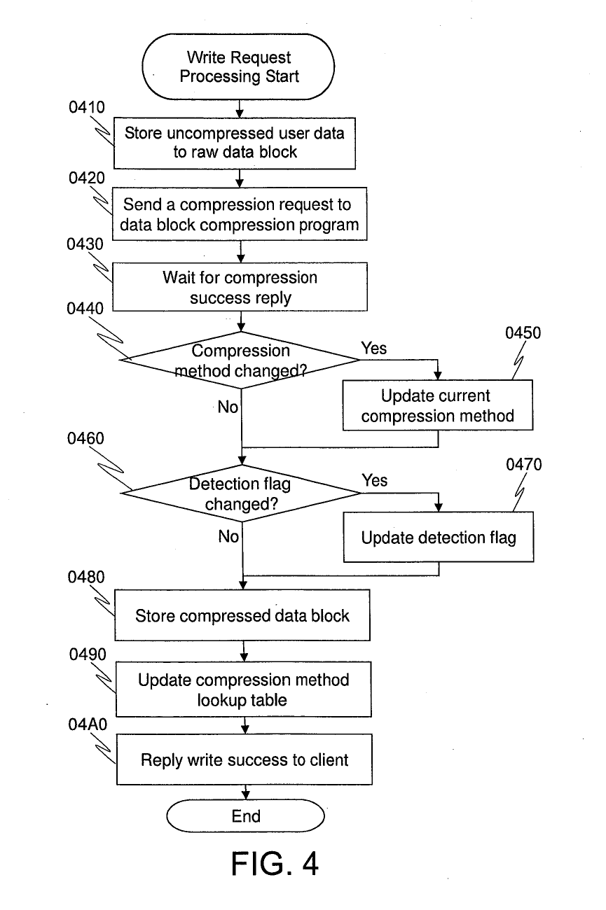

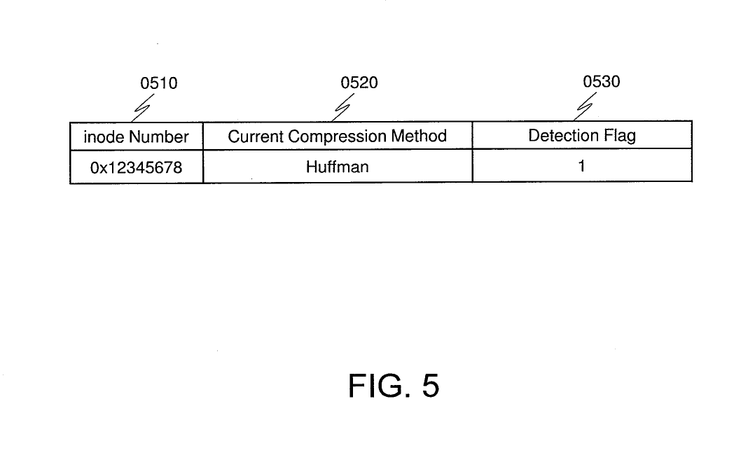

FIG. 4 is a flow diagram illustrating the exemplary steps, executed by a file system program 0276 in a storage system 0110, to serve a write request from the client 0120, according to the first embodiment. In Step 0410, upon receiving the write request, the storage system stores the uncompressed user data into a raw data block 0278. In Step 0420, the storage system sends a compression request to the data block compression program 0272. A compression request includes the memory address of the raw data block 0278, the memory address of a compressed data block 0279, a current compression method 0520, and a detection flag 0530 (see FIG. 5) to indicate whether or not a property detection is needed. The current compression method 0520 and the detection flag 0530 are maintained in an inode of a file in which the data block is stored. In Step 0430, the storage system waits for a compression success reply from the data block compression program 0720.

FIG. 5 shows an example of the structure of an inode according to the first embodiment. An inode includes, but is not limited to, three elements, including inode number 0510, current compression method 0520, and detection flag 0530. The inode number 0510 is a unique identifier assigned to a file. The current compression method 0520 indicates a compression method (e.g., Huffman compression, dictionary compression, etc.) that should be used to compress a raw data block 0278, which will be further described herein below. Initially, the current compression method 0520 is set to “NULL”. The detection flag 0530 with a value “1” indicates that data property detection is needed for the next writing data block. Otherwise, the detection flag 0530 is set to “0”. Initially, the detection flag 0530 is set to “1”.

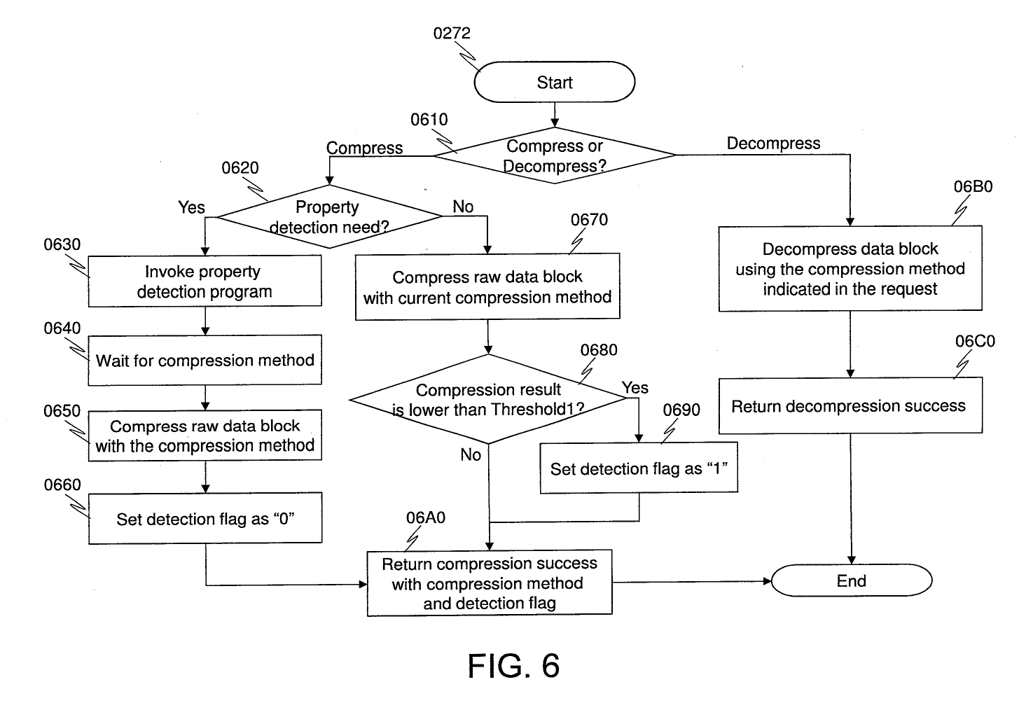

FIG. 6 is a flow diagram illustrating the exemplary steps of a data block compression program 0272, upon receiving a compression request (from Step 0420 in FIG. 4), according to the first embodiment. In Step 0610, the storage system checks if the received request is a compression request or a decompression request. For a compression request, in Step 0620, the storage system further checks if a property detection is needed or not, by checking the detection flag in the request. If property detection is needed, in Step 0630, the storage system then invokes a property detection program 0271, and waits for a reply indicating the compression method in Step 0640.

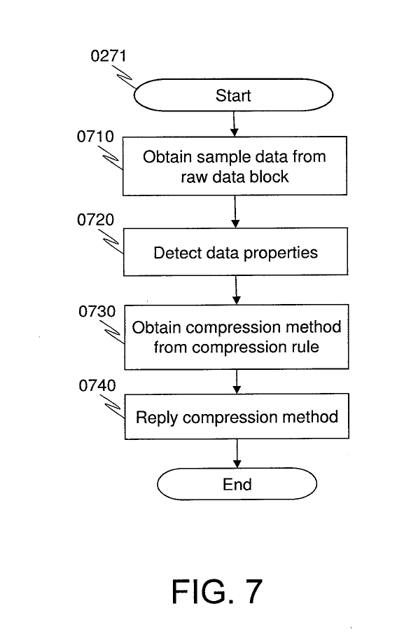

FIG. 7 is a flow diagram illustrating the exemplary steps of a property detection program 0271. In Step 0710, the storage system obtains sample data from the raw data block 0278, with given memory address. For example, the size of the sample data can be predefined as a percentage (e.g., 50%) of the raw data block. In Step 0720, the storage system then detects data properties, using the sample data instead of the entire data. In Step 0730, the storage system then obtains a compression method by searching a compression rule 0274, with the data properties detected. In Step 0740, the property detection program 0271 then sends a reply with the obtained compression method to the data block compression program 0272 (in response to step 0630 in FIG. 6).

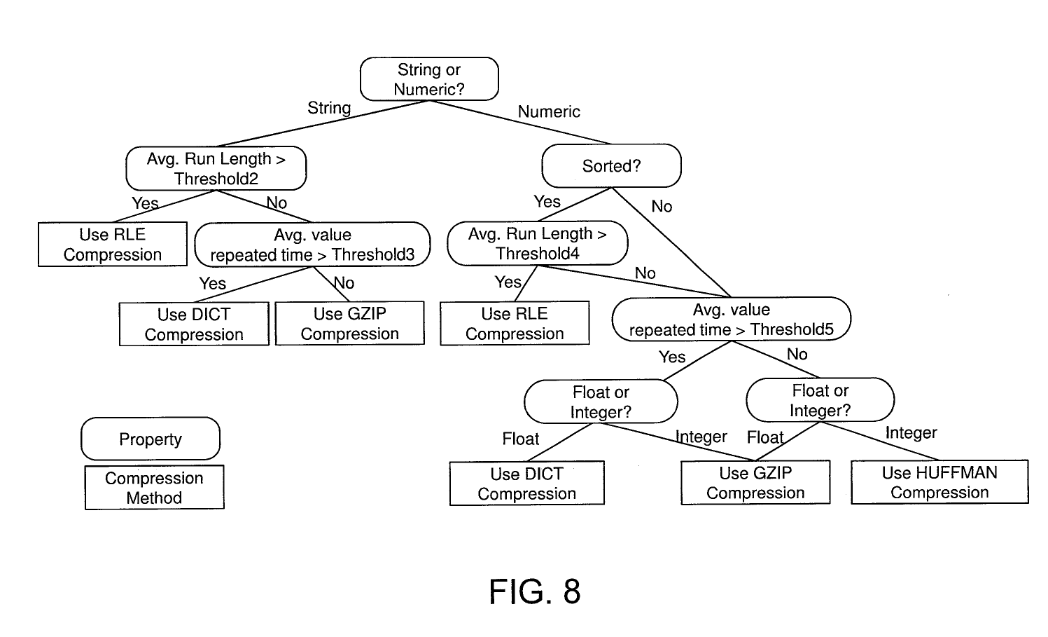

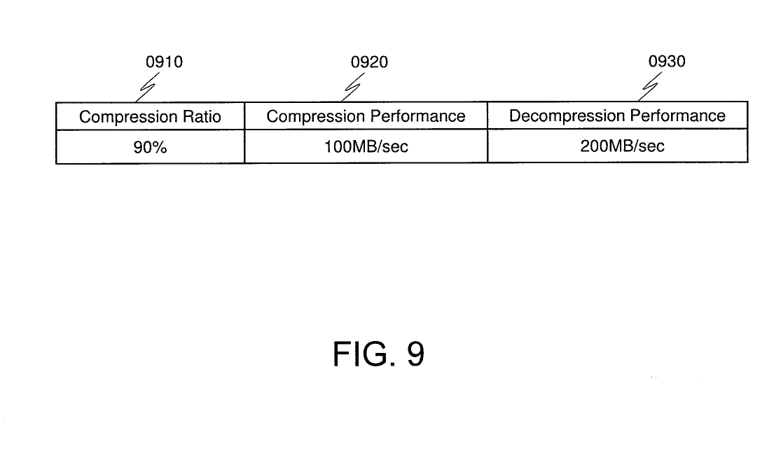

FIG. 8 shows an example of a compression rule 0274 and data properties may be detected from the sample data. Based on the properties of the sample data, a compression method can be obtained by searching the compress rule 0274. A compression rule 0274 can be defined by a system administrator, so that a compression goal 0273 (refer to FIG. 9) can be achieved by a storage system 0110. It should be noted that different compression rules 0274 can be defined for different compression goals 0273, based on the requirement on both compression ratio and performance. The compression methods used in one compression rule 0274 can be different from another compression rule. All the compression methods are implemented in the compression method library 0275. For instance, let us assume that the compression goal is to achieve 90% compression ratio and higher compression performance than GZIP. As shown in FIG. 8, if the sample data consists of strings, and the average run length of a string (defined as the continuously repeated time of a string) is larger than 10 (a predefined threshold, referred to as Threshold2 or run length threshold), then a Run Length Encoding (RLE) compression method will be used. In a RLE compression, if a string “StringA” continuously repeats n times, such as (StringA, StringA, . . . , StringA), it can be compressed as (StringA, n). Only if the average run length of strings is larger than 10, then the compression goal can be achieved (90% compression ratio, and higher compression performance than GZIP as RLE is a lightweight compression method compared to GZIP).

On the other hand, if the average run length is smaller than Threshold2, but the average repeated time of strings is larger than a predefined threshold, referred to as Threshold3 or repeated time threshold, then a Dictionary (DICT) compression method will be used. In a DICT compression, repeated strings, such as (StringA, StringB, StringA, StringC, StringB, . . . ) can be compressed as (0,1,0,2,1, . . . ), where “0” represent StringA, “1” represent StringB, and so on, in the dictionary. Typically, when the average repeated time of strings is higher, the dictionary will consist of fewer entries, and each entry can be represented with smaller number of bytes. Consequently, the compression ratio will be higher. Therefore, based on the compression goal 0273, Threshold3 can be determined.

It should be noted that more properties may be defined and corresponding compression methods can be used to compress the data, in order to achieve a compression goal 0273. If none of the properties can be detected, then GZIP may be used to compress the data as best effort to achieve at least same compression ratio and performance as GZIP.

As shown in the example of FIG. 8, if the sample data is numeric instead, the next question is whether the numeric data is sorted or not. If the data is sorted and if the average run length is greater than Threshold4 or run length threshold, a RLE compression method will be used. If the data is sorted and if the average run length is not greater than Threshold4, or if the data is not sorted, then the next question is whether the average value of repeated time is greater than Threshold5 or repeated time threshold. If the average value of repeated time is greater than Threshold5 and if the numeric data is float, a DICT compression method will be used. If the average value of repeated time is greater than Threshold5 and if the numeric data is integer, a GZIP compression method will be used. If the average value of repeated time is not greater than Threshold5 and if the numeric data is float, a GZIP compression method will be used. If the average value of repeated time is not greater than Threshold5 and if the numeric data is integer, a HUFFMAN compression method will be used.

FIG. 9 shows an example of the structure of a compression goal 0273, which includes a compression ratio 0910, a compression performance 0920, and a decompression performance 0930. A compression ratio 0910 is a percentage value (e.g., 90%), which is defined as [1−(size of compressed data/size of raw data)]. A compression performance 0920 and a decompression performance 0930 may be defined quantitatively (such as 100 MB/sec) or relatively (e.g., 50% faster than GZIP).

Referring back to FIG. 6, in Step 0650, the storage system compresses the raw data block with the compression method, and sets the detection flag as “0” in Step 0660. If property detection is not needed in Step 0620, then in Step 0670, the storage system compresses the raw data block with a current compression method in the request. In Step 0680, the storage system checks if the compression result (e.g., compression ratio or compression performance) is lower than a predefined threshold, referred to as Threshold) or compression result threshold. If Yes, the storage system sets detection flag as “1” in Step 0690. In Step 06A0 (following Step 0660 or Step 0680 or Step 0690), the data block compression program 0272 returns compression success (in response to the compression request from Step 0420 in FIG. 4) with the compression method used to compress the raw data block, and the detection flag.

Referring back to FIG. 4, in Step 0440, upon receiving the compression success reply, the storage system checks if the compression method is changed. If Yes, in Step 0450, the storage system updates the current compression method 0520 in the inode. In Step 0460, the storage system further checks if the detection flag is changed. If yes, in Step 0470, the storage system updates the detection flag 0530 in the inode. In Step 0480, the storage system stores the compressed data block into HDD 0240, and inserts a new entry to a compression method lookup table 0277 in Step 0490. Lastly, in Step 04A0, the storage system sends a reply of write success to the client 0120.

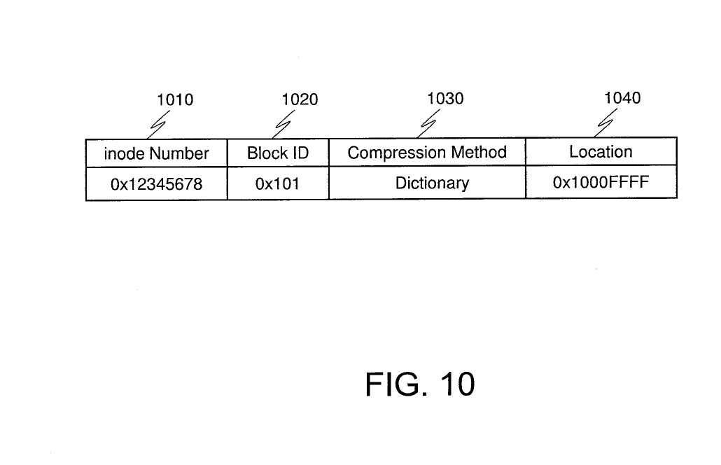

FIG. 10 shows an example of the structure of a compression method lookup table 0277, which includes, but is not limited to, four columns, including an inode number 1010, a block ID 1020, a compression method 1030, and location 1040. The inode number 1010 is a unique identifier assigned to a file (same as 0510 in FIG. 5). The block ID 1020 is a unique identifier assigned to a raw data block 0278 of a file. The compression method 1030 indicates a compression method that is used to compress the raw data block. The location 1040 indicates the address where the compressed data block is stored in the HDD 0240.

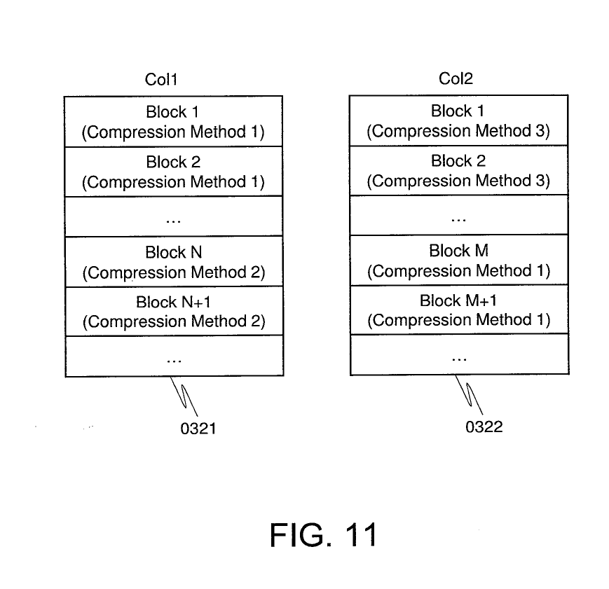

FIG. 11 shows an example illustrating that the data blocks of different columns 0321, 0322 (referring to the example in FIG. 3) may be compressed with different compression methods, and data blocks belonging to the same column may also be compressed with different compression methods, by using the aforementioned data block compression method.

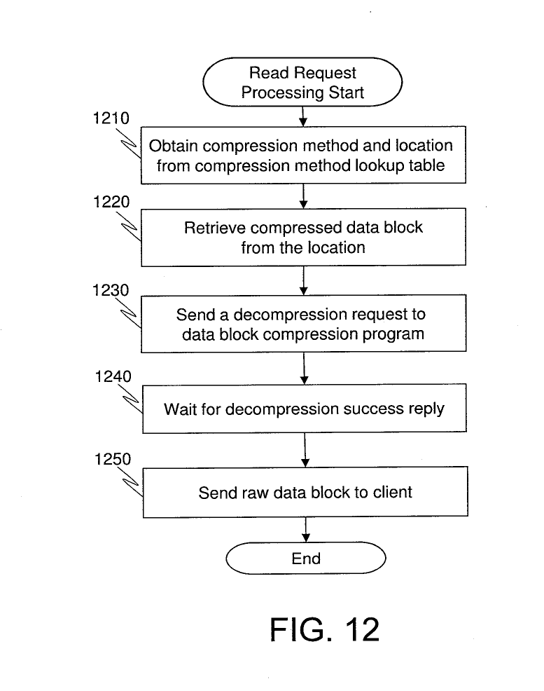

FIG. 12 is a flow diagram illustrating the exemplary steps, executed by a file system program 0276 in a storage system 0110, to serve a read request from a client 0120, according to the first embodiment. In Step 1210, the storage system obtains the compression method 1030 and location 1040 for the requested data block (identified by the inode number 1010 and block ID 1020) from a compression method lookup table 0277. In Step 1220, the storage system retrieves the compressed data from the location 1040 and stores it into a compressed data block 0279. In Step 1230, the storage system sends a decompression request to a data block compression program 0272. A decompression request contains the memory address of a compressed data block 0279, the memory address of a raw data block 0278 where uncompressed data will be stored, and a compression method. In Step 1240, the storage system waits for a decompression success reply, and sends raw data block to a client 0120 in Step 1250.

Referring back to FIG. 6, for a decompression request, in Step 06B0, the storage system 0110 decompresses the data block 0279 using the compression method indicated in the request, and stores the uncompressed data in the raw data block. In Step 06C0, the data block compression program returns decompression success (in response to the decompression request from Step 1230 in FIG. 12).

### Embodiment 2

A second embodiment of the present invention will be described in the following. The description will mainly focus on the differences from the first embodiment.

In the first embodiment, a data block compression program 0272 is executed by the processor 0210 in a storage system, which may degrade the performance of the storage system due to the usage of the processor power. Therefore, in the second embodiment, compression methods in a compression method library and a data block compression program can be implemented and executed by a processor or an application-specific integrated circuit (ASIC) in a Flash device (i.e., a Flash memory device). By leveraging the computation power in a Flash device, performance degradation at the storage system 0110 can be eliminated.

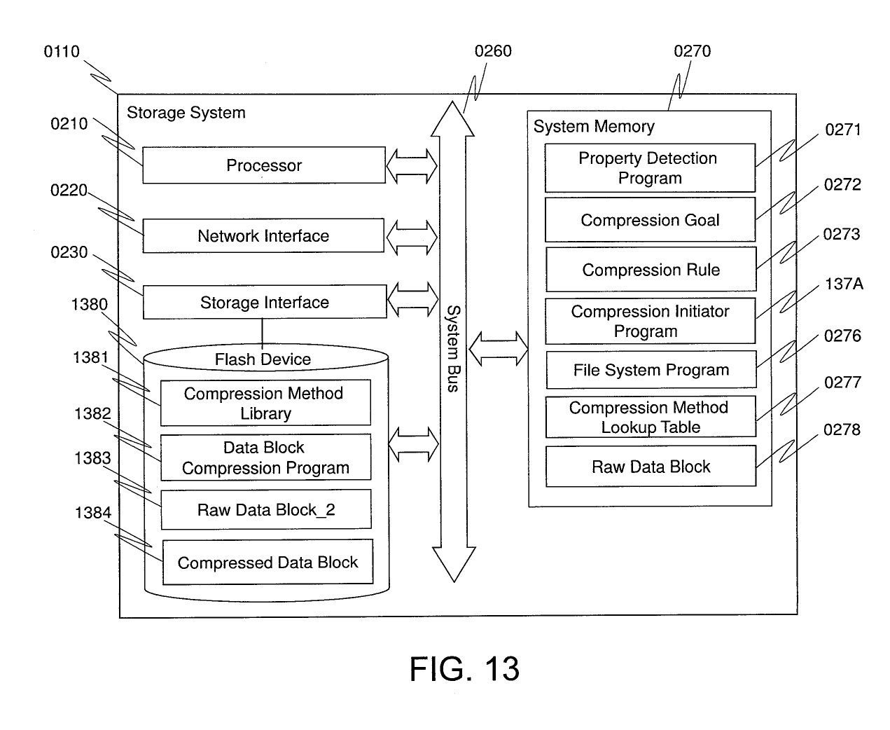

FIG. 13 is a block diagram illustrating an example of the components within a storage system 0110 according to the second embodiment. The storage system 0110 now includes a Flash device 1380, in which a compression method library 1381 and a data block compression program 1382 are implemented. The flash device further includes, but is not limited to, a raw data block_2 1383 and a compressed data block 1384. Uncompressed data in a raw data block 0278 of the system memory 0270 is further stored in the raw data block_2 1383, and then the data will be compressed and stored in the compressed data block 1384. The storage interface 0230 manages a plurality of Flash devices 1380 and provides raw data storage to store the compressed data blocks. The system memory 0270 further includes a compression initiator program 137A.

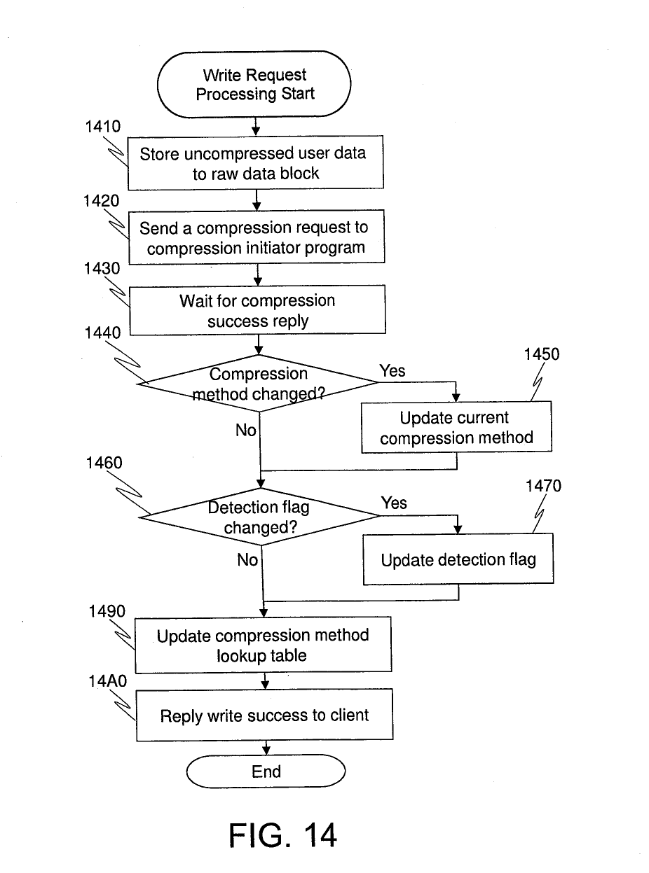

FIG. 14 is a flow diagram illustrating the exemplary steps, executed by a file system program 0276 in a storage system 0110, to serve a write request from a client 0120, according to the second embodiment. Step 1410 to Step 1470 are the same as Step 0410 to Step 0470 in FIG. 4, except that in Step 1420, the storage system sends a compression request to a compression initiator program 137A (instead of a data block compression program), which will be further described herein below. After Step 1460 or Step 1470, in Step 1490, the storage system inserts a new entry to a compression method lookup table 0277, and in Step 14A0, sends a reply of write success to the client 0120.

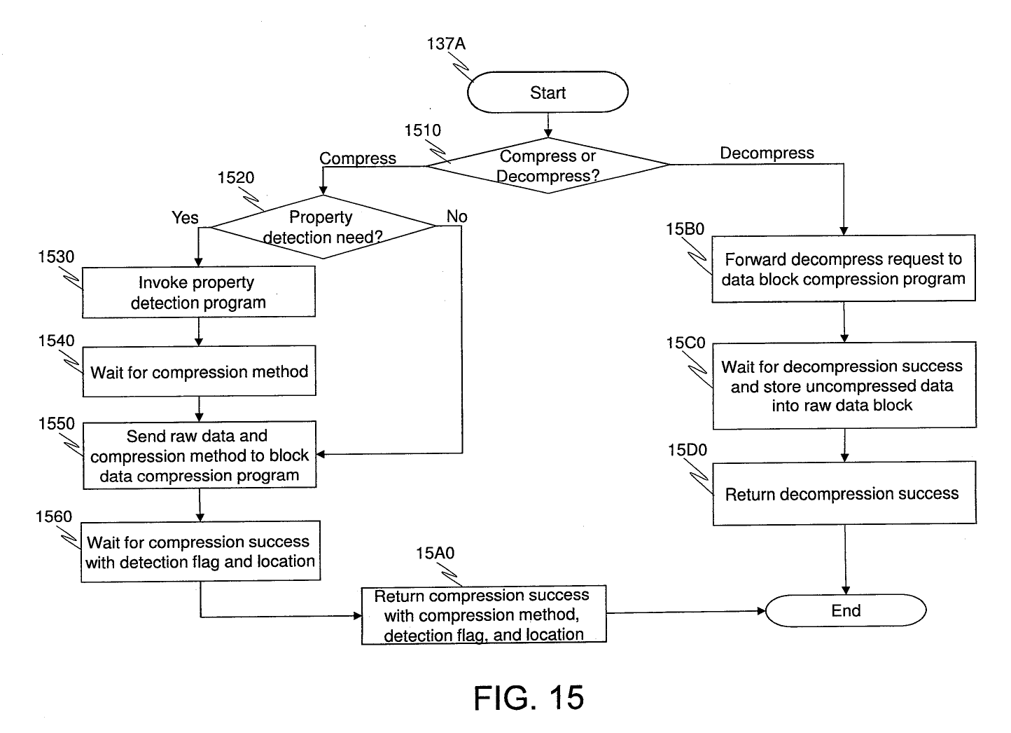

FIG. 15 is a flow diagram illustrating the exemplary steps of a compression initiator program 137A, upon receiving a compression request (from Step 1420 in FIG. 14). In Step 1510, the storage system checks if the received request is a compression request or a decompression request. For a compression request, in Step 1520, the storage system further checks if property detection is needed or not, by checking the detection flag in the request. If property detection is needed, in Step 1530, the storage system then invokes a property detection program 0271 (refer to FIG. 7), and waits for the compression method from execution of the property detection program 0271 in Step 1540. In Step 1550, the storage system sends the raw data and compression method to the data block compression program 1382 in the flash device 1380. In Step 1560, the storage system waits for a compression success reply, together with a detection flag and location where the compressed data are stored, from the flash device 1380. In Step 15A0, the compression initiator program 137A returns compression success with compression method used to compress the raw data block, a detection flag, and the location (in response to the compression request from Step 1420 in FIG. 14). If property detection is not needed in Step 1520, only Step 1550, Step 1560, and Step 15A0 are then executed.

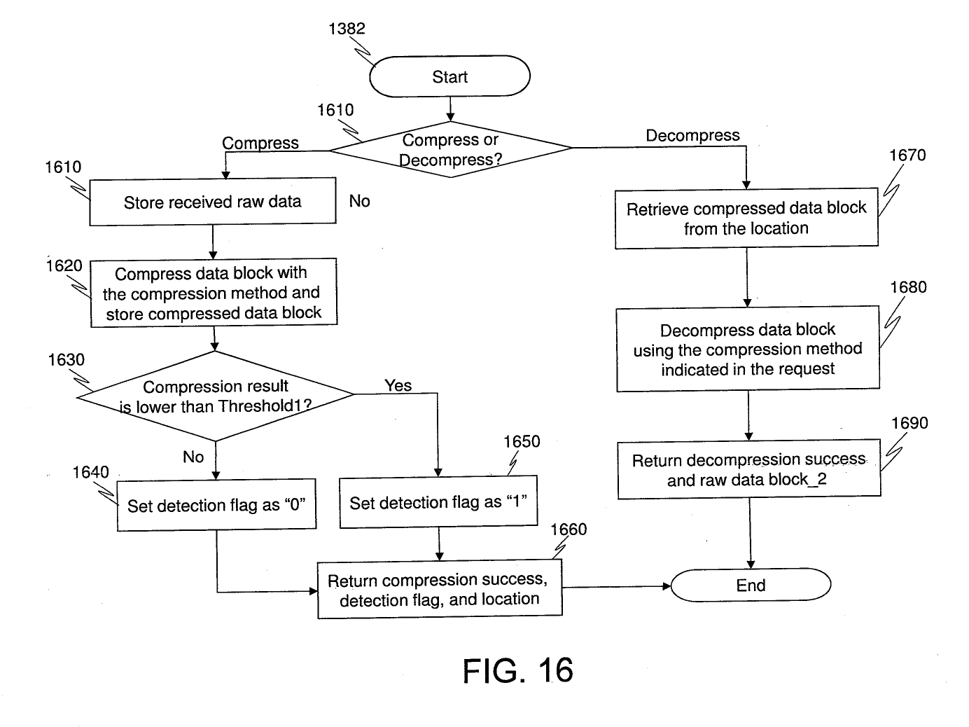

FIG. 16 is a flow diagram illustrating the exemplary steps of a data block compression program 1382, executed by a flash device 1380 in a storage system 0110, upon receiving a compression request (from Step 1550 in FIG. 15), according to the second embodiment. In this embodiment, the flash device 1380 has a controller or processor that executes the data block compression program 1382. In Step 1610, the flash device checks if the received request is a compression request or a decompression request. For a compression request, in Step 1620, the flash device compresses the raw data block with the compression method in the request, and stores the compressed data block. In Step 1630, the flash device checks if the compression result (e.g., compression ratio or compression performance) is lower than a Threshold1. If No, the flash device sets detection flag as “0” in Step 1640. Otherwise, the flash device set detection flag as “1” in Step 1650. In Step 1660, the data block compression program 1382 returns compression success with the detection flag and location where the compressed data are stored in the flash device 1380 (in response to the compression request from Step 1550 in FIG. 15).

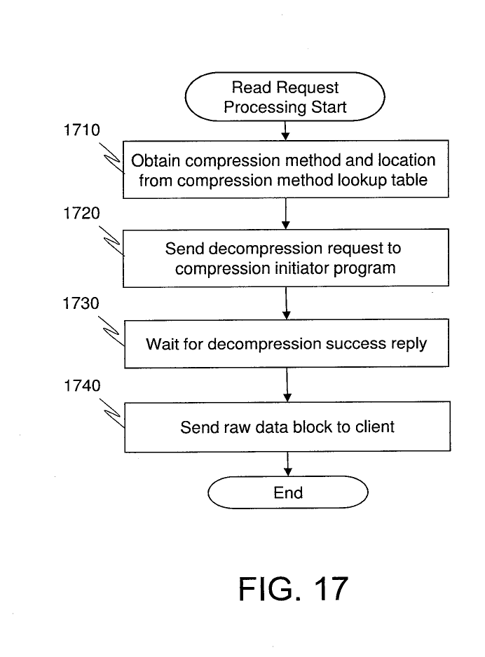

FIG. 17 is a flow diagram illustrating the exemplary steps, executed by a file system program 0276 in a storage system 0110, to serve a read request from a client 0120, according to the second embodiment. In Step 1710, the storage system obtains the compression method 1030 and location 1040 for the requested data block (identified by the inode number 1010 and block ID 1020) from a compression method lookup table 0277. In Step 1720, the storage system sends a decompression request to a compression initiator program 137A. In Step 1730, the storage system waits for a decompression success reply and sends raw data block to a client 0120, in Step 1740.

Referring back to FIG. 15, in a compression initiator program 137A executed in a storage system 0110, for a decompression request, in Step 1560, the storage system 0110 forwards the decompression request to a data block compression program 1382, executed in a flash device 1380. In Step 15C0, the storage system then waits for a decompression success reply and stores uncompressed data into a raw data block 0278. Lastly, the compression initiator program 137A returns decompression success (in response to the decompression request from Step 1720 in FIG. 17).

Referring back to FIG. 16, in a data block compression program 1382 executed in a flash device 1380, for a decompression request, in Step 1670, the flash device retrieves the compressed data from the location 1040 and stores it into a compressed data block 1384. In Step 1680, the flash device decompresses the data block 1384 using the compression method indicated in the request, and stores the uncompressed data in a raw data block_2 1383. In Step 1690, the data block compression program returns decompression success, and uncompressed data in raw data block_2 (in response to the decompression request from Step 15B0 in FIG. 15).

This invention can be used to compress data in a storage system, in which:

(1) The system chooses a compression method without compressing data, based on characteristics of data content and a compression rule, and then compresses data using the chosen compression method.

(2) The compression method can be changed, if the characteristics of data content changes and the compression ratio or performance is under a threshold value.

(3) Data compression methods can be implemented in a Flash device, and the system indicates the Flash device to compress data using the chosen compression method.

Of course, the system configuration illustrated in FIG. 1 is purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for content-aware data compression. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A storage system comprising a storage media and a controller, the controller being operable to:
determine a compression method to be used to compress a data block of uncompressed data based on one or more characteristics of data content of the uncompressed data prior to compressing the data block; and
compress the data block of the uncompressed data using the determined compression method.

2. The storage system according to claim 1,
wherein the controller is operable to determine the compression method based on a compression rule which relates one or more characteristics of data content and compression methods.

3. The storage system according to claim 1, wherein the one or more characteristics of data content comprise one or more of:
whether the data is string data or numeric data;
if the data is string data, whether the data has an average run length larger than a run length threshold;
if the data is numeric data, whether the data is sorted or not;
whether the data has an average value repeated time larger than a repeated time threshold; or
whether the data is float or integer.

4. The storage system according to claim 1, wherein the controller is operable to:
determine a compression result of the compressed data block;
compare the compression result with a compression result threshold;
if the compression result is below the compression result threshold, decide that the compression method can be changed for a next data block of uncompressed data to be compressed; and
if the compression result is not below the compression result threshold, decide that the compression method cannot be changed for the next data block of uncompressed data to be compressed.

5. The storage system according to claim 4, wherein information on whether the compression method can be changed or not and the compression method are stored in the storage media; and wherein the controller is operable to:
prior to determining a compression method to be used to compress the next data block of uncompressed data, check the stored information on whether the compression method can be changed or not;
if the stored information indicates that the compression method can be changed, then determine a next compression method to be used to compress the next data block of uncompressed data based on one or more characteristics of data content of the uncompressed data prior to compressing the next data block, and compress the next data block of the uncompressed data using the determined next compression method; and
if the stored information indicates that the compression method cannot be changed, then compress the next data block of the uncompressed data using the stored compression method.

6. The storage system according to claim 1, wherein the controller is operable to:
detect data content of sample data of the data block of the uncompressed data; and
use the data content of the sample data to determine the compression method to be used to compress the data block.

7. The storage system according to claim 1, further comprising a flash memory device which includes the controller to determine the compression method and to compress the data block, wherein the controller in the flash memory device is operable to:
determine a compression result of the compressed data block;
compare the compression result with a compression result threshold;
if the compression result is below the compression result threshold, decide that the compression method can be changed for a next data block of uncompressed data to be compressed; and
if the compression result is not below the compression result threshold, decide that the compression method cannot be changed for the next data block of uncompressed data to be compressed.

8. The storage system according to claim 7, wherein information on whether the compression method can be changed or not and the compression method are stored in the storage media; and further comprising a system controller which is operable to:
prior to determining a compression method to be used to compress the next data block of uncompressed data, check the stored information on whether the compression method can be changed or not;
if the stored information indicates that the compression method can be changed, then request the flash memory device to determine a next compression method to be used to compress the next data block of uncompressed data based on one or more characteristics of data content of the uncompressed data prior to compressing the next data block, and to compress the next data block of the uncompressed data using the determined next compression method; and
if the stored information indicates that the compression method cannot be changed, then request the flash memory device to compress the next data block of the uncompressed data using the stored compression method.

9. A method of compressing data in a storage system which includes a storage media, the method comprising:
determining a compression method to be used to compress a data block of uncompressed data based on one or more characteristics of data content of the uncompressed data prior to compressing the data block; and
compressing the data block of the uncompressed data using the determined compression method.

10. The method according to claim 9,
wherein the compression method is determined based on a compression rule which relates one or more characteristics of data content and compression methods.

11. The method according to claim 9, wherein the one or more characteristics of data content comprise one or more of:
whether the data is string data or numeric data;
if the data is string data, whether the data has an average run length larger than a run length threshold;
if the data is numeric data, whether the data is sorted or not;
whether the data has an average value repeated time larger than a repeated time threshold; or
whether the data is float or integer.

12. The method according to claim 9, further comprising:
determining a compression result of the compressed data block;
comparing the compression result with a compression result threshold;
if the compression result is below the compression result threshold, deciding that the compression method can be changed for a next data block of uncompressed data to be compressed; and
if the compression result is not below the compression result threshold, deciding that the compression method cannot be changed for the next data block of uncompressed data to be compressed.

13. The method according to claim 12, wherein information on whether the compression method can be changed or not and the compression method are stored in the storage media, and wherein the method further comprises:
prior to determining a compression method to be used to compress the next data block of uncompressed data, checking the stored information on whether the compression method can be changed or not;
if the stored information indicates that the compression method can be changed, then determining a next compression method to be used to compress the next data block of uncompressed data based on one or more characteristics of data content of the uncompressed data prior to compressing the next data block, and compressing the next data block of the uncompressed data using the determined next compression method; and
if the stored information indicates that the compression method cannot be changed, then compressing the next data block of the uncompressed data using the stored compression method.

14. The method according to claim 9, further comprising:
detecting data content of sample data of the data block of the uncompressed data; and
using the data content of the sample data to determine the compression method to be used to compress the data block.

15. The method according to claim 9, wherein the storage system includes a flash memory device which performs said determining the compression method and said compressing the data block, and wherein the method further comprises:
determining, by the flash memory device, a compression result of the compressed data block;
comparing, by the flash memory device, the compression result with a compression result threshold;
if the compression result is below the compression result threshold, deciding, by the flash memory device, that the compression method can be changed for a next data block of uncompressed data to be compressed; and
if the compression result is not below the compression result threshold, deciding, by the flash memory device, that the compression method cannot be changed for the next data block of uncompressed data to be compressed.

16. The method according to claim 15, wherein information on whether the compression method can be changed or not and the compression method are stored in the storage media, wherein the storage system further includes a system controller, and wherein the method further comprises:
prior to determining a compression method to be used to compress the next data block of uncompressed data, checking, by the system controller, the stored information on whether the compression method can be changed or not;
if the stored information indicates that the compression method can be changed, then requesting, by the system controller, the flash memory device to determine a next compression method to be used to compress the next data block of uncompressed data based on one or more characteristics of data content of the uncompressed data prior to compressing the next data block, and to compress the next data block of the uncompressed data using the determined next compression method; and
if the stored information indicates that the compression method cannot be changed, then requesting, by the system controller, the flash memory device to compress the next data block of the uncompressed data using the stored compression method.
